(19) United States
(12) Patent Application Publication
(10) Pub. No.: US 2009/0323733 A1
(43) Pub. Date: Dec. 31, 2009

(54) Blue laser and light cure polymers

(76) Inventor: Ahmad Fawaz Charkas, Troy, MI (US)

Correspondence Address: AHMAD FAWAZ CHARKAS, 1062 VILLA PARK DR., TROY, MI, 48085, US

(21) Appl. No.: 12/164,048

(22) Filed: Jun. 28, 2008

(51) Int. Cl. H01S 3/30; H01S 3/13

(52) U.S. Cl. 372/5; 372/29.01

(57) ABSTRACT

Portable, battery charged, compact, laser instrument is presented for polymerizing light cure polymer that is used in civil engineering, aerospace engineering, medical and dental. Blue laser beam with wave length of 473 nm generated from semiconductor laser diode.

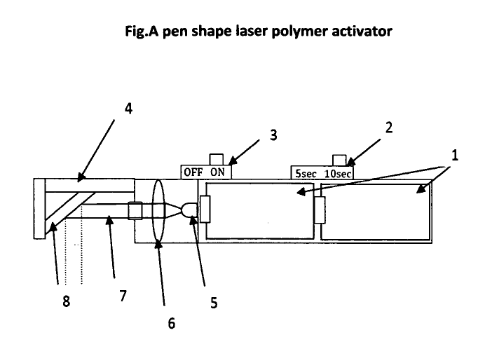

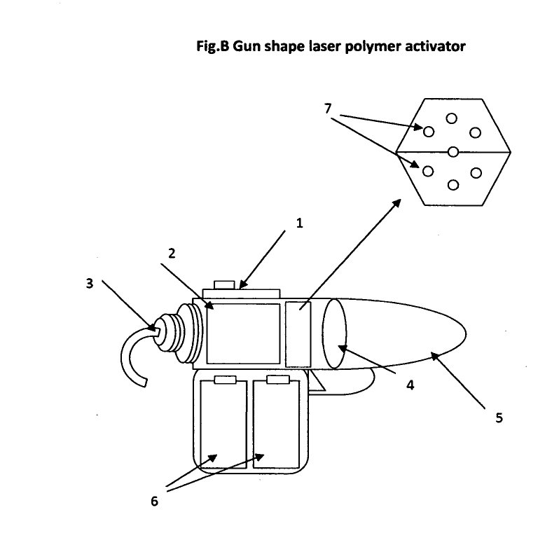

### BACKGROUND

Shimoji. in U.S. Pat. No. 5,928,220 discloses a Cordless dental and surgical laser that emits two wavelengths. The first is of at least 472 nm and at most 474 nm and being used to cure dental composite, and the second one is of at least 354 nm and at most 356 nm which generates UV light for the purpose of sterilization. In this patent the wavelength was not specified at 473 nm, and the photo-initiator was not specified.

“Dental light-curing units are devices that emit light within a specific wavelength for the purpose of curing or hardening resin-based restorative materials. In the most frequently used light-curing units, the light is generated by a halogen bulb and boosted by a reflective mirror attached to the bulb. Other light-curing devices include argon laser curing units, plasma arc curing units, and most recently, blue light emitting diodes (blue LED).” according to JOURNAL OF ESTHETIC AND RESTORATIVE DENTISTRY (André V. Ritter).

One of the main problems of using the devices mentioned above, except for the laser units, have limited curing depth.

Although argon laser curing units, plasma arc curing units have considerable curing depth, they generate multi-wavelength some of which must be filtered before curing process. Thus power is wasted. The blue laser with 473 nm wavelength is very close to the peak absorption wavelength of the photo-initiator (camphoroquinone.) Recently, composite materials made of fibers embedded in a polymeric resin, also known as fiberreinforced polymers, have become an alternative to steel reinforcement for concrete structures. Aramid fiber reinforced polymer (AFRP), carbon fiber reinforced polymer (CFRP), and glass fiber reinforced polymer (GFRP) rods are the commercially available products for the construction industry.

Composites are composed of resins, reinforcements, fillers, and additives which are cured by chemical or thermal activation. Adding photo-initiator to the FRP resin (camphoroquinone) will eliminate the need of applying heat and mixing several chemicals to polymerize the FRP. Light curing FRP by blue laser will reduce the time between curing and loading the FRP sheets, beams or rod.

### BRIEF DESCRIPTION OF THE DRAWINGS

This invented device will be clearer when accompanying with the following drawings, wherein:

FIG. A illustrates side views of pen shaped laser polymer activator;
1—1 represents two AAA rechargeable batteries used as a power supply for the device.
2—2 represents a switch that controls the exposure timing to last either for 5 or 10 sec.
3—3 represents an On/Off switch to control the power.
4—4 represents an extension arm originates from the device body and extends with right angle arm to hold the reflection mirror.
5—5 represents the LED that produces a 473 nm wavelength beam to be absorbed by the polymer.
6—6 represents convex lens to focus the laser beam.
7—7 represents the laser beam.
8—8 represents the reflecting mirror mounted in a 45 degrees.

FIG. B illustrates side views of gun shaped laser polymer activator;
1. 1 represents a switch that controls the exposure timing to last either for 5 or 10 sec.
2. 2 represents the power supply for the device. This power supply gives the voltages needed for the device to operate properly. It also supplies the regulated current needed to charge the batteries. Therefore, this device operates using the batteries or a regulated AC power.
3. 3 represents the power cord of the device.
4. 4 represents convex lens to focus the laser beam.
5. 5 represents a light guide that guides the beam to the polymer.
6. 6 represents rechargeable batteries.
7. 7 represents a cross-section that shows how the LEDs are being mounted.

1- A pen shape device to be used in curing light cure polymers that have camphoroquinone molecules as photo-initiator that corresponds to a spectrum range of 400-500 nm. The blue laser beam with 473 nm wave length will be used to cure light cure polymers such as dental composite, bonding agents, prefabricated crowns and bridges, bonding orthodontics braces and complete and partial dentures.

2- The laser instrument in claim 1 consists of cylindrical metal body that contains two AAA rechargeable batteries and semiconductor laser generator with a switch to set working time to say 5 or 10 seconds.

3- The laser instrument in claim 1 has a mounted mirror at 45 degree to reflect the blue laser beam which has the 473 nm wavelength say to cure the target, filling, bonding agent, crowns, bridges, denture.

4- The laser instrument in claim 1 has an output of 15 mwatt.

5- A gun shaped laser instrument emitting a blue laser beam to polymerize FRP (fiber reinforced Polymers.)

6- The laser instrument in claim 5 has multiple blue laser LEDs forming a hexagon shape. With 20 mwatt power each.

7- The laser instrument in claim 5 with blue laser beam with 473 nm wavelength passes through a collimating convex lens after emitted from the LED source to cure the FRP with desired thickness that the beam can penetrate.

8- The power supply for the instrument in claim 5 is either batteries or a regulated voltage source.

9- A timer to control the curing time for the polymerization of say FRP to match the minimum required time.
